(19) United States
(12) Patent Application Publication
(10) Pub. No.: US 2015/0234196 A1
(43) Pub. Date: Aug. 20, 2015

(54) IMAGE DISPLAY APPARATUS, LENTICULAR LENS, AND IMAGE DISPLAY METHOD

(71) Applicant: FUJITSU LIMITED, Kawasaki-shi (JP)

(72) Inventor: Toshiro OHBITSU, Akishima (JP)

(21) Appl. No.: 14/699,870

(22) Filed: Apr. 29, 2015

Related U.S. Application Data
(63) Continuation of application No. PCT/JP2012/083130, filed on Dec. 20, 2012.

(51) Int. Cl. G02B 27/22

(52) U.S. Cl. CPC G02B 27/2214

(57) ABSTRACT

An image display apparatus displays a 3D image that is viewable from multiple viewpoints. An image display unit displays a first image on a first pixel group, and a second image on a second pixel group, and a third image on a third pixel group. The first image is an image having parallax relative to the second image, and the second image is an image having parallax relative to the first image. The third image is an image that is superimposed on the second image to prevent pseudoscopic perception of a viewer. A view zone setting unit sets view zones of the images (first image, second image, and third image) displayed by the image display unit. The view zone setting unit sets the view zone of the third image at a superimposed view zone that is superimposed on a part of a left-eye image view zone.

### CROSS-REFERENCE TO RELATED APPLICATION

This application is a continuation application of International Application PCT/JP2012/083130 filed on Dec. 20, 2012 which designated the U.S., the entire contents of which are incorporated herein by reference.

### FIELD

The embodiments discussed herein relate to an image display apparatus, a lenticular lens, and an image display method.

### BACKGROUND

Known image display apparatuses display three-dimensional (3D) images that are viewable from multiple viewpoints. When a 3D image that is viewable from multiple viewpoints is displayed, a viewer can view the 3D image only from a specific area, and therefore relative position between an image display apparatus and a viewer is important. As an example of technology relevant to relative position between an image display apparatus and a viewer, there is a display method that switches an image displayed on pixels between a left eye image and a right eye image, depending on position of a viewer's head.

Also, when a 3D image that is viewable from multiple viewpoints is displayed, a viewer views a pseudoscopic image at some viewpoints, i.e. views a right eye image with the left eye and a left eye image with the right eye. As an example of technology relevant to pseudoscopic perception, there is a 3D display device that periodically and cyclically displays a right eye image, a left eye image, and a non-displaying area with a same width, so as to present the non-displaying area to a viewer at pseudoscopic viewpoints for the purpose of preventing pseudoscopic perception.

See, for example, Japanese Laid-open Patent Publication Nos. 9-233500 and 9-297284.

At pseudoscopic viewpoints, a viewer views an unnatural image and thereby suffers discomfort. Also, when a right eye image, a left eye image, and a non-displaying area are displayed periodically and cyclically with a same width, a viewer always views a non-displaying area in a fixed proportion of viewing field, and therefore the unnatural viewing proportion is large.

### SUMMARY

According to one aspect, there is provided an image display apparatus for displaying a 3D image that is viewable from multiple viewpoints, including: an image display unit that displays a first image, a second image, and a third image; and a view zone setting unit that sets a view zone of the first image at a right-eye image view zone, and a view zone of the second image at a left-eye image view zone, and a view zone of the third image at a superimposed view zone that is adjacent to one of the right-eye image view zone and the left-eye image view zone and is superimposed on a part of the other of the right-eye image view zone and the left-eye image view zone, at a boundary between the right-eye image view zone and the left-eye image view zone.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an exemplary configuration of an image display apparatus and an example of view region of a 3D image according to a first embodiment;

FIG. 2 illustrates an exemplary configuration of an image display apparatus and an example of view region of a 3D image according to a second embodiment;

FIG. 3 is an explanatory diagram of relationship between viewpoints of a viewer and images that the viewer views;

FIG. 4 illustrates a view example of the image display apparatus according to the second embodiment, from a three-dimensional viewpoint;

FIG. 5 illustrates a view example of the image display apparatus according to the second embodiment, from a pseudoscopic viewpoint;

FIG. 6 illustrates a view example of the image display apparatus according to the second embodiment, from a superimposed image viewpoint;

FIG. 7 illustrates an example of a pixel array of a monitor of the image display apparatus according to the second embodiment;

FIG. 8 illustrates relationship between a pixel array of the monitor and a lens array of the image display apparatus according to the second embodiment;

FIG. 9 illustrates an exterior appearance of a lens sheet of the image display apparatus according to the second embodiment;

FIG. 10 is an explanatory diagram of attachment of the lens sheet to the monitor;

FIG. 11 is an explanatory diagram of a view zone formed by a lenticular lens;

FIG. 12 is an explanatory diagram of shapes of cylindrical lenses of respective pixel groups;

FIG. 13 is an explanatory diagram of a shape of a superimposition pixel group imaging lens;

FIG. 14 illustrates an exemplary hardware configuration of the image display apparatus according to the second embodiment;

FIG. 15 illustrates a flowchart of a display control process executed by the image display apparatus according to the second embodiment;

FIG. 16 illustrates an example of a view zone array table;

FIG. 17 illustrates an example of a pixel array of a monitor of an image display apparatus according to a third embodiment; and

FIG. 18 illustrates relationship between a pixel array of the monitor and cylindrical lenses in the image display apparatus according to the third embodiment.

### DESCRIPTION OF EMBODIMENTS

Several embodiments will be described below with reference to the accompanying drawings, wherein like reference numerals refer to like elements throughout.

### First Embodiment

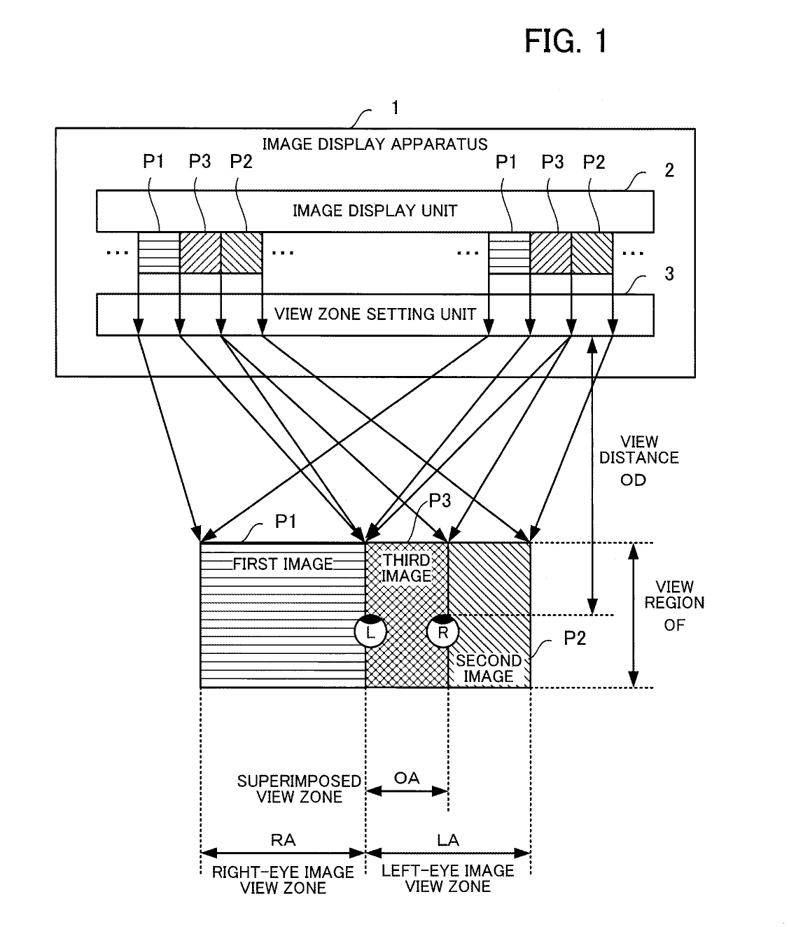

FIG. 1 illustrates an exemplary configuration of an image display apparatus and an example of view region of a 3D image according to a first embodiment. In FIG. 1, the image display apparatus 1 displays a 3D image that is viewable from multiple viewpoints. The image display apparatus 1 includes an image display unit 2 and a view zone setting unit 3.

The image display unit 2 displays an image on a plurality of unit pixels. The image display unit 2 sets three pixel groups in advance, and displays a first image P1 on a first pixel group, a second image P2 on a second pixel group, and a third image P3 on a third pixel group. The first image P1 is a right eye image, and the second image P2 is a left eye image, and the third image P3 is a superimposition image that is to be superimposed on the first image P1 or the second image P2. The first image P1 has parallax relative to the second image P2, and the second image P2 has parallax relative to the first image P1 (stereoscopic image). The third image P3 is to be superimposed on the first image P1 or the second image P2 to prevent pseudoscopic perception of a viewer. Note that, in the present embodiment, the third image P3 is superimposed on the second image P2.

The image display unit 2 is a display device, such as a liquid crystal display (LCD), a cathode ray tube (CRT), a plasma display panel (PDP), and an organic electro-luminescence (OEL) display.

The view zone setting unit 3 sets view zones of the images (first image P1, second image P2, and third image P3) that the image display unit 2 displays. The view zone setting unit 3 sets the view zone of the first image P1 at a right-eye image view zone RA, and the view zone of the second image P2 at a left-eye image view zone LA. The right-eye image view zone RA and the left-eye image view zone LA are adjacent to each other and repeatedly located according to the number of viewpoints (3D image viewpoints). Further, the view zone setting unit 3 sets the view zone of the third image P3 at a superimposed view zone OA that is adjacent to the right-eye image view zone RA and is superimposed on a part of the left-eye image view zone LA at a boundary between the right-eye image view zone RA and the left-eye image view zone LA. The view zone setting unit 3 sets the view zone of the third image P3 in such a manner that the view zone of the third image P3 is narrower than the first image P1 and the second image P2.

Thereby, a viewer can view a 3D image displayed by the image display apparatus 1 from the view region OF, and the view region OF includes the right-eye image view zone RA from which the first image P1 is viewable, the left-eye image view zone LA from which the second image P2 is viewable, and the superimposed view zone OA from which the second image P2 and the third image P3 are viewable. The view region OF is set at a region around a position a view distance OD away either from the image display unit 2 or the view zone setting unit 3, within a predetermined range from that position.

Thus, when a viewer moves toward right from a flat viewing state in which both eyes (left eye L and right eye R) are positioned in the right-eye image view zone RA, to search for a three-dimensional viewpoint, the right eye R moves into the superimposed view zone OA to view a superimposed image composed of the second image P2 and the third image P3. The third image P3 is superimposed on the second image P2, to prevent pseudoscopic perception in which the left eye L views the first image P1 and the right eye R views the second image P2. In this situation, a viewer does not view a pseudoscopic image, and thereby unnaturalness of the viewed image is reduced. Also, a viewer can know that a three-dimensional viewpoint is not to the right and try moving toward left.

As described above, the image display apparatus 1 reduces pseudoscopic perception and leads a viewer to a correct viewpoint. Also, since the third image P3 is superimposed on the left-eye image view zone LA, the image display apparatus 1 is needless to provide a view zone in which only the third image P3 is viewable, between the right-eye image view zone RA and the left-eye image view zone LA. This allows the zone for viewing the third image P3, which is not to be displayed innately, to be narrower so as to reduce unnaturalness of an image to a viewer.

Note that pseudoscopic perception can be completely eliminated by setting the width of the superimposed view zone OA equal to or larger than the distance between eyes of a viewer.

Also, the image display apparatus 1 may be configured such that the view zone setting unit 3 sets the view zone of the third image P3 at a superimposed view zone that is adjacent to the left-eye image view zone LA and is superimposed on a part of the right-eye image view zone RA at a boundary between the right-eye image view zone RA and the left-eye image view zone LA.

### Second Embodiment

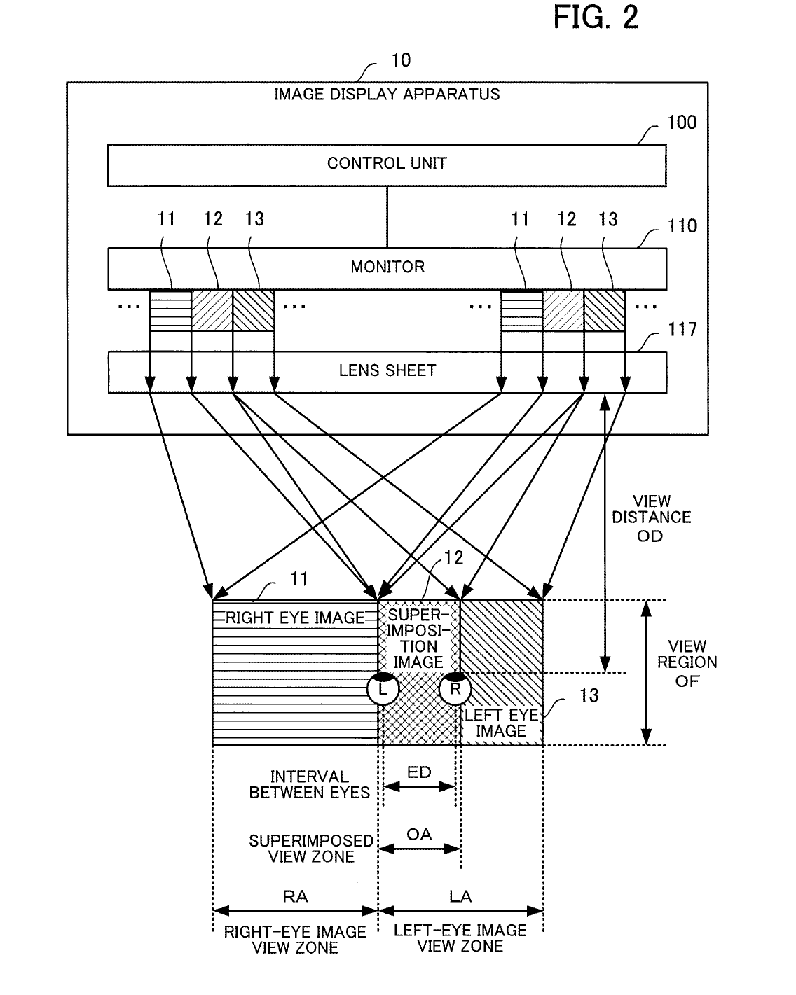

Next, an image display apparatus of a second embodiment will be described. FIG. 2 illustrates an exemplary configuration of the image display apparatus and an example of view region of a 3D image according to the second embodiment. In FIG. 2, the image display apparatus 10 displays a 3D image that is viewable from multiple viewpoints. The image display apparatus 10 includes a control unit 100, a monitor 110, and a lens sheet 117.

The control unit 100 outputs a display image to the monitor 110. The display image includes a right eye image 11, a superimposition image 12, and a left eye image 13. The right eye image 11 has parallax relative to the left eye image 13, and the left eye image 13 has parallax relative to the right eye image 11. The superimposition image 12 impairs parallax of the left eye image 13 relative to the right eye image 11, when superimposed on the left eye image 13. The control unit 100 generates a complementary color image of the left eye image 13, as the superimposition image 12, from the left eye image 13 on which it is to be superimposed. When superimposed on the left eye image 13, the generated superimposition image 12 becomes a uniform white image by impairing parallax of the left eye image 13 relative to the right eye image 11.

The monitor 110 displays an image on a plurality of unit pixels. The monitor 110 displays the right eye image 11 on a right-eye pixel group, and the left eye image 13 on a left-eye pixel group, and the superimposition image 12 on a superimposition pixel group. The monitor 110 is a LCD, for example. Note that the monitor 110 may be a display device, such as a CRT, a PDP, or an OEL.

The lens sheet 117 is an optical device that sets light paths of outgoing light from respective pixels of the monitor 110. In the lens sheet 117, the lenticular lens refracts light paths of outgoing light from the respective pixels of the monitor 110, to limit the zone where a viewer can view the outgoing light.

The lens sheet 117 converges light from the right eye image 11 to a right-eye image view zone RA, and light from the left eye image 13 to a left-eye image view zone LA. The right-eye image view zone RA and the left-eye image view zone LA are adjacent to each other and repeatedly located according to the number of viewpoints (3D image viewpoints).

Further, the lens sheet 117 converges light from the superimposition image 12 to a superimposed view zone OA that is adjacent to the right-eye image view zone RA and is superimposed on a part of the left-eye image view zone LA at a boundary between the right-eye image view zone RA and the left-eye image view zone LA. The lens sheet 117 refracts light paths in such a manner that the superimposed view zone OA is narrower than the right-eye image view zone RA and the left-eye image view zone LA. In this case, the width of the superimposed view zone OA is set equal to or larger than a distance ED between eyes. This prevents pseudoscopic perception in which a viewer's right eye R views the left eye image 13 and a viewer's left eye L views the right eye image 11.

Note that the distance ED between eyes is, for example, 65 mm. The distance ED between eyes is set as appropriate according to target viewers. For example, the distance ED between eyes is set at 55 mm for children, and 70 mm for specific target viewers. Also, the image display apparatus 10 may include a parallax barrier, instead of the lens sheet 117, to set light paths of outgoing light from respective pixels of the monitor 110.

In a view region OF, a 3D image displayed by the image display apparatus 10 is viewable. The view region OF is set at a region around a position a predetermined view distance OD away either from the monitor 110 or the lens sheet 117, within a predetermined range from that position. The lens sheet 117 sets light paths of outgoing light from the monitor 110 in such a manner that the light paths are directed toward the view region OF.

Thereby, the view region OF includes a right-eye image view zone RA from which the right eye image 11 is viewable, a left-eye image view zone LA from which the left eye image 13 is viewable, and a superimposed view zone OA from which the superimposition image 12 and the left eye image 13 are viewable.

Thus, when a viewer moves toward right from a flat viewing state in which both eyes are positioned in the right-eye image view zone RA, to search for a three-dimensional viewpoint, the right eye R moves into the superimposed view zone OA to view a superimposed image composed of the superimposition image 12 and the left eye image 13. In this case, the superimposition image 12 is superimposed on the left eye image 13, to prevent pseudoscopic perception in which the left eye L views the right eye image 11 and the right eye R views the left eye image 13. The viewer can know that the right eye R and the left eye L are at a position where pseudoscopic image was viewed originally, by viewing the superimposition image 12. Also, the viewer can know that a three-dimensional viewpoint is not to the right in the moving direction and try moving toward left.

As described above, the image display apparatus 10 prevents pseudoscopic perception and leads a viewer to a correct viewpoint. Also, since the superimposition image 12 is superimposed on the left-eye image view zone LA, the image display apparatus 10 is needless to provide a view zone in which only the superimposition image 12 is viewable, between the right-eye image view zone RA and the left-eye image view zone LA. This allows the zone for viewing the superimposition image 12 to be narrower.

Also, the width of the left-eye image view zone LA, which includes a part that overlaps the superimposed view zone OA, is freely set under a condition that the width of the left-eye image view zone LA is larger than the width of the superimposed view zone OA. This increases the degree of freedom in designing the image display apparatus 10 including the lens sheet 117.

Note that the image display apparatus 10 may be configured such that the lens sheet 117 sets the view zone of the superimposition image 12 at a superimposed view zone that is adjacent to the left-eye image view zone LA and is superimposed on a part of the right-eye image view zone RA at a boundary between the right-eye image view zone RA and the left-eye image view zone LA.

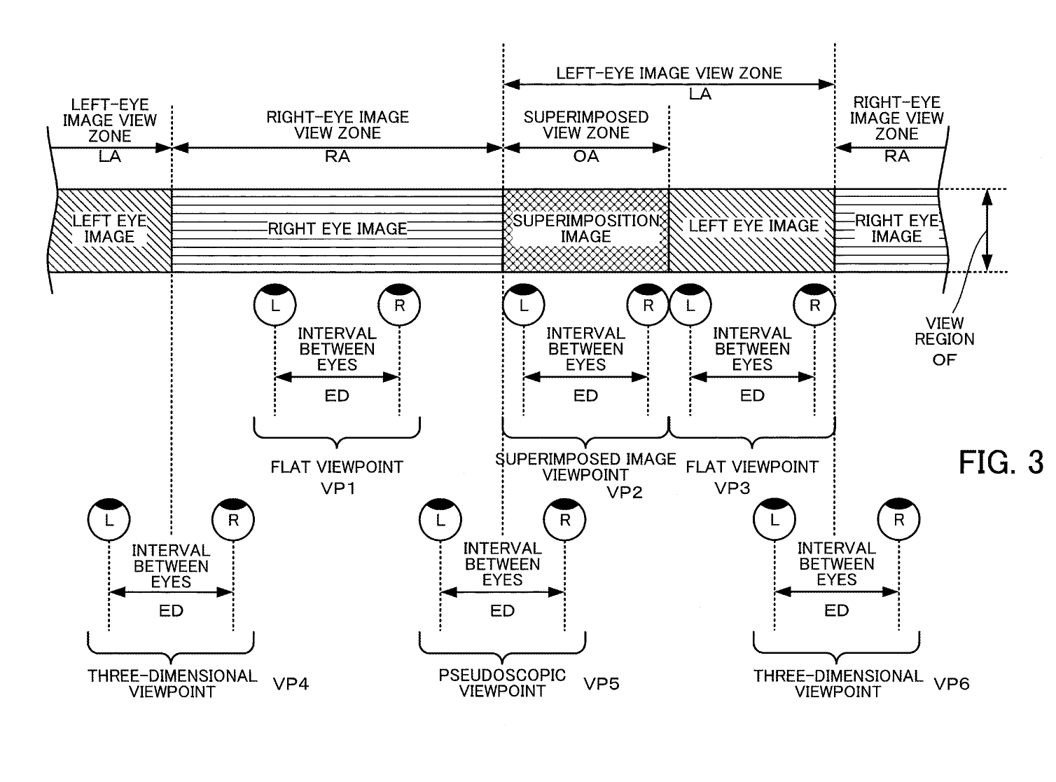

Next, with reference to FIGS. 3 to 6, images viewed from respective viewpoints in the view region OF will be described. FIG. 3 is an explanatory diagram of relationship between viewpoints of a viewer and images that a viewer views. Note that, in FIG. 3, the left eye L and the right eye R are not illustrated in the view region OF to depict both eyes clearly, but are in the view region OF actually.

In the view region OF, the right-eye image view zone RA and the left-eye image view zone LA are repeatedly located in a left-right direction, so as to be adjacent to each other, with the image display apparatus 10 at front. Further, in the view region OF, there is a superimposed view zone OA that is adjacent to the right-eye image view zone RA and is superimposed on a part of the left-eye image view zone LA at a boundary between the right-eye image view zone RA and the left-eye image view zone LA.

A viewer is in the view region, when the viewer views a screen image from a position a view distance OD away from the front face of the image display apparatus 10 with the image display apparatus 10 at front. In this case, a viewer can view a 3D image, with the left eye L positioned in the left-eye image view zone LA and the right eye R positioned in the right-eye image view zone RA. The view region OF includes a plurality of three-dimensional viewpoints at which a 3D image is viewable. For example, there are a three-dimensional viewpoint VP4 and a three-dimensional viewpoint VP6.

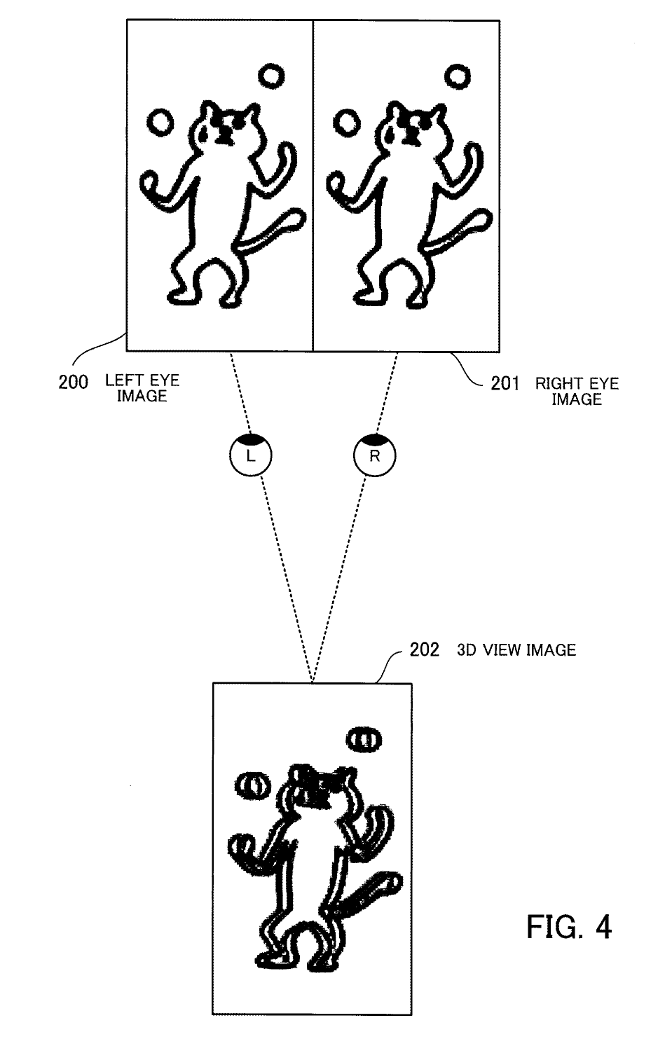

At the three-dimensional viewpoint VP4, a viewer can view the image illustrated in FIG. 4, for example. FIG. 4 illustrates a view example of the image display apparatus according to the second embodiment, from a three-dimensional viewpoint. At the three-dimensional viewpoint VP4, a viewer views the left eye image 200 with the left eye L and views the right eye image 201, which includes parallax relative to the left eye image 200, with the right eye R. Since the viewed images (left eye image 200 and right eye image 201) of both eyes include parallax, a viewer views a 3D view image 202. At the viewpoints (three-dimensional viewpoint VP4 and three-dimensional viewpoint VP6), a viewer can preferably view an image three-dimensionally, when the boundary between the left-eye image view zone LA and the right-eye image view zone RA is positioned between the eyes.

Also, the view region OF includes a plurality of flat viewpoints. For example, there are a flat viewpoint VP1 and a flat viewpoint VP3 in FIG. 3. The flat viewpoint VP1 is a viewpoint at which both eyes of a viewer are positioned at the right-eye image view zone RA. For example, at the flat viewpoint VP1, a viewer views the right eye image 201 with both eyes without 3D perception, since there is no parallax in the images viewed by both eyes. The flat viewpoint VP3 is a viewpoint at which both eyes of a viewer are positioned at the left-eye image view zone LA. For example, at the flat viewpoint VP3, a viewer views the left eye image 200 with both eyes without 3D perception, since there is no parallax in the images viewed by both eyes. At such viewpoints (flat viewpoint VP1 and flat viewpoint VP3), a viewer moves toward left or right to search for a three-dimensional viewpoint.

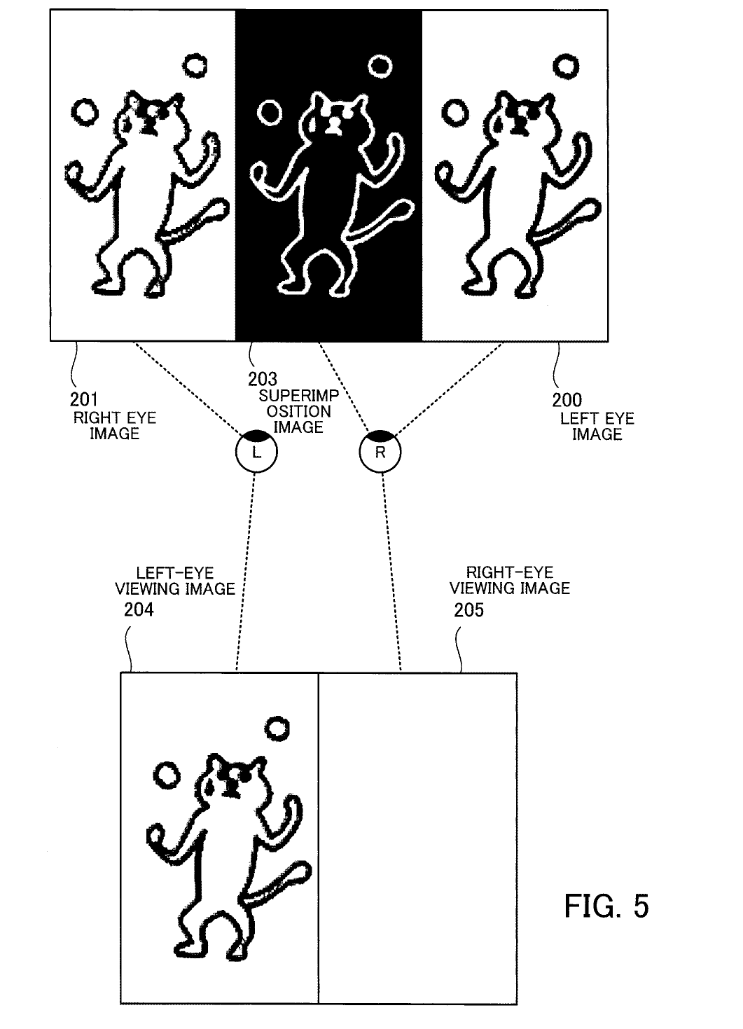

When a viewer moves toward left or right to search for a three-dimensional viewpoint, the viewer can move to a pseudoscopic viewpoint at which the left eye L is positioned in the right-eye image view zone RA, and the right eye R is positioned in the left-eye image view zone LA. There are a plurality of pseudoscopic viewpoints in the view region OF. For example, there is a pseudoscopic viewpoint VP5 illustrated in FIG. 3. At the pseudoscopic viewpoint VP5, a viewer can view an image illustrated in FIG. 5, for example.

FIG. 5 illustrates a view example of the image display apparatus according to the second embodiment, from a pseudoscopic viewpoint. At the pseudoscopic viewpoint VP5, a viewer views the right eye image 201 with the left eye L and views the left eye image 200, which includes parallax relative to the right eye image 201, with the right eye R. If the image viewed by the right eye R were only the left eye image 200, a viewer would feel discomfort by viewing a stereoscopic image (left eye image 200 and right eye image 201) with both eyes in a left-right reversed manner.

However, since the image display apparatus 10 provides a superimposed view zone OA that is adjacent to the right-eye image view zone RA and is superimposed on the left-eye image view zone LA, a viewer simultaneously views the left eye image 200 and the superimposition image 203. Thus, a viewer views the right eye image 201 with the left eye L, and the left eye image 200 and the superimposition image 203 with the right eye R. Thereby, a viewer views a left-eye viewing image 204 with the left eye L, and a right-eye viewing image 205 with the right eye R.

Since the superimposition image 203 is a complementary color image in relation to the left eye image 200, the right-eye viewing image 205, which is created by superimposing the superimposition image 203 on the left eye image 200, is a white image as illustrated in FIG. 5.

As described above, the superimposition image 203 impairs parallax of the left eye image 200 in relation to the right eye image 201. Thereby, since there is no parallax in the images viewed by both eyes, a viewer does not view a pseudoscopic image at the pseudoscopic viewpoint VP5 of FIG. 3. At such a viewpoint (pseudoscopic viewpoint VP5), a viewer can easily know that the viewer is at a pseudoscopic viewpoint VP5 from the right-eye viewing image 205, and moves toward left or right to search for a three-dimensional viewpoint, for example.

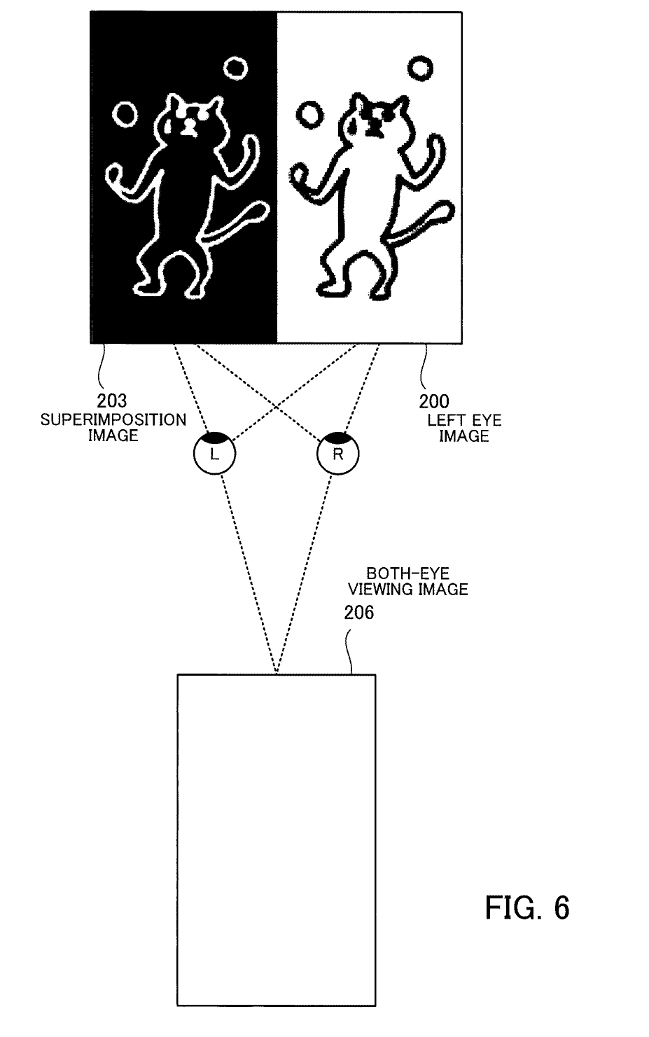

If the width of the superimposed image viewpoint VP2 is larger than the distance between eyes of a viewer, the viewer can move to a superimposed image viewpoint at which both eyes are positioned in the superimposed view zone OA, while the viewer moves toward left or right to search for a three-dimensional viewpoint. There are a plurality of superimposed image viewpoints in the view region OF. For example, there is a superimposed image viewpoint VP2. At the superimposed image viewpoint VP2, a viewer can view an image illustrated in FIG. 6, for example.

FIG. 6 illustrates a view example of the image display apparatus according to the second embodiment, from the superimposed image viewpoint. At the superimposed image viewpoint VP2, a viewer simultaneously views the left eye image 200 and the superimposition image 203 with both eyes. Thereby, a viewer views a both-eye viewing image 206 with both eyes. At such a viewpoint (superimposition image viewpoint VP2), a viewer can easily know that the viewer is at the superimposed image viewpoint VP2 from the both-eye viewing image 206, and moves toward left or right to search for a three-dimensional viewpoint, for example.

As described above, the image display apparatus impairs parallax at the pseudoscopic viewpoint, to prevent a viewer from viewing a pseudoscopic image. Thus, the image display apparatus 10 can offer a preferable view environment to a viewer.

Also, in the image display apparatus 10, the left-eye image view zone LA and the right-eye image view zone RA are arrayed without an undisplayed region between the left-eye image view zone LA and the right-eye image view zone RA. This allows the zone for viewing the superimposition image 12 to be relatively narrow, and reduces the probability of occurrence of situation where a viewer views the unnatural superimposition image 12. As a result, a viewer feels less unnaturalness.

Note that, in the technology that prevents pseudoscopic perception by displaying a right eye image, a left eye image, and a non-displaying area periodically and cyclically with a same width, the zone for viewing the non-displaying area always occupies a fixed proportion in the entire region. Hence, as the zone for viewing the correct image is enlarged, the zone for viewing the non-displaying area is also enlarged, resulting in more unnaturalness to a viewer.

In contrast, in the image display apparatus 10, the width of the superimposed view zone OA for viewing the superimposition image 12 is at least the distance between eyes of a viewer. Meanwhile, the widths of the right-eye image view zone RA and the left-eye image view zone LA can be enlarged without restriction. Thus, as compared to Japanese Laid-open Patent Publication No. 9-297284, the zone for viewing the superimposition image 12 is made narrower.

Also, as the degree of freedom in designing the right-eye image view zone RA and the left-eye image view zone LA increases, the degree of freedom in designing each unit, such as the lens sheet 117, of the image display apparatus 10 increases as well. As a result, the production cost of the image display apparatus 10 is reduced.

Although the superimposition image 203 is a complementary color image of the left eye image 200, the superimposition image 203 is not limited thereto as far as the image impairs parallax of the left eye image 200 in relation to the right eye image 201. For example, the superimposition image 203 may be a specific image, such as a checkerboard pattern and a noise pattern, or a processed image generated by processing the left eye image 200 through an information amount reduction process, such as mosaic and blur.

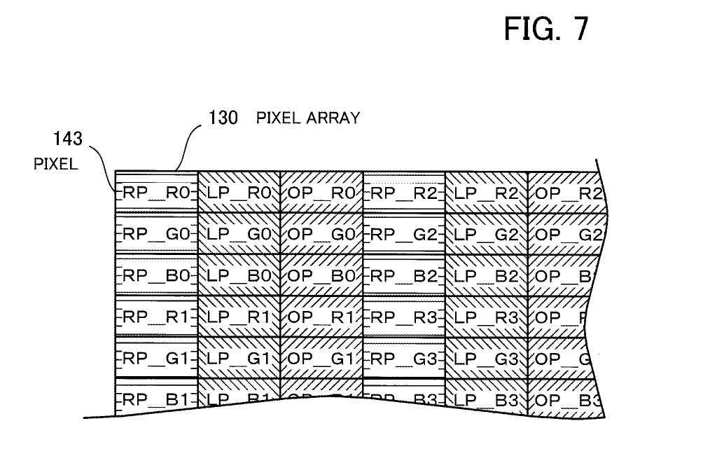

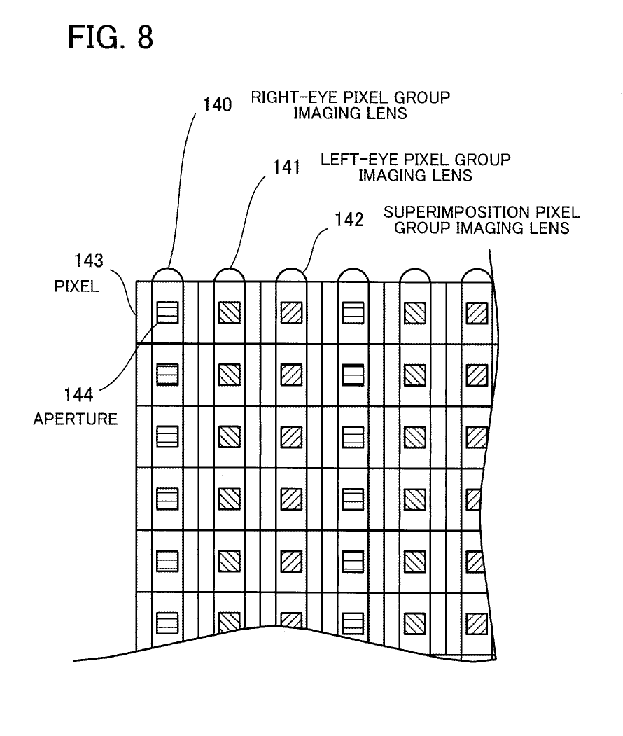

Next, with reference to FIGS. 7 and 8, relationship between a pixel array of the monitor 110 and a lens array of the lens sheet 117 will be described. First, the pixel array of the monitor will be described.

In the monitor 110, pixels are vertically and laterally arranged in a matrix. An image displayed by the monitor 110 is configured as a collection of pixels of a plurality of color components. A pixel is a minimum display unit of each color component for composing an image. An image includes pixels of red (R) component, green (G) component, and blue (B) component. In the following, a pixel of R component, a pixel of G component, and a pixel of B component are referred to as “R pixel”, “G pixel”, and “B pixel”, respectively.

Also, the minimum unit of pixels of different color components in an image for expressing one color is referred to as “pixel group”. One pixel group includes a pixel of R component, a pixel of G component, and a pixel of B component, which are adjacent to each other in a predetermined direction.

In a stereoscopic image displayed by the monitor 110, the right eye image 11, the left eye image 13, and the superimposition image 12 are divided into rectangular strips for each pixel group, which are arrayed in the lateral direction. Then, divided regions corresponding to the right eye image 11, divided regions corresponding to the left eye image 13, and divided regions corresponding to the superimposition image 12 are arranged alternatingly in the lateral direction.

Here, a pixel array example illustrated in FIG. 7 will be described. FIG. 7 illustrates an example of a pixel array of the monitor of the image display apparatus according to the second embodiment.

The pixel array 130 is a pixel array example of the monitor 110. The pixel group including pixels 143 (“RP_R0”, “RP_G0”, “RP_B0”, “RP_R1”, “RP_G1”, “RP_B1”, . . . ) arrayed in the vertical direction is the first pixel group of the right eye image 11 as counted from the left. The pixel group including pixels 143 (“LP_R0”, “LP_G0”, “LP_B0”, “LP_R1”, “LP_G1”, “LP_B1”, . . . ) arrayed in the vertical direction is the first pixel group of the left eye image 13 as counted from the left. The pixel group including pixels 143 (“OP_R0”, “OP_G0”, “OP_B0”, “OP_R1”, “OP_G1”, “OP_B1”, . . . ) arrayed in the vertical direction is the first pixel group of the superimposition image 12 as counted from the left. In the same way, pixel groups of the right eye image 11, pixel groups of the left eye image 13, and pixel groups of the superimposition image 12 are arrayed repeatedly in the lateral direction.

The lens sheet 117 is positioned corresponding to the pixel groups that are divided into rectangular strips. The relationship between a pixel array of the monitor 110 and a lens array of the lens sheet 117 is illustrated in FIG. 8. FIG. 8 illustrates the relationship between the pixel array of the monitor and the lens array of the image display apparatus according to the second embodiment.

The lens sheet 117 is a lenticular lens which includes a plurality of cylindrical lenses each extending in the vertical direction and arrayed in the lateral direction. The cylindrical lenses include right-eye pixel group imaging lenses 140, left-eye pixel group imaging lenses 141, and superimposition pixel group imaging lenses 142. The right-eye pixel group imaging lenses 140, the left-eye pixel group imaging lenses 141, and the superimposition pixel group imaging lenses 142 are cyclically arrayed in the lateral direction of the lens sheet 117.

The right-eye pixel group imaging lenses 140 are provided corresponding to the right-eye pixel groups including the pixels 143 arrayed in the vertical direction. The left-eye pixel group imaging lenses 141 are provided corresponding to the left-eye pixel groups including the pixels 143 arrayed in the vertical direction. The superimposition pixel group imaging lenses 142 are provided corresponding to the superimposition pixel groups including the pixels 143 arrayed in the vertical direction. Thereby, outgoing lights from an R pixel, a G pixel, and a B pixel of a pixel group form an image in the view region OF, to constitute one pixel for displaying a color. For example, with the right-eye pixel group imaging lens 140, the R pixel “RP_R0”, the G pixel “RP_G0”, and the B pixel “RP_B0” form an image in the view region OF to express one pixel for displaying a color.

Note that each pixel 143 includes an aperture 144 for projecting a light, and each cylindrical lens is positioned to collect outgoing light from the apertures 144 of the corresponding pixels 143.

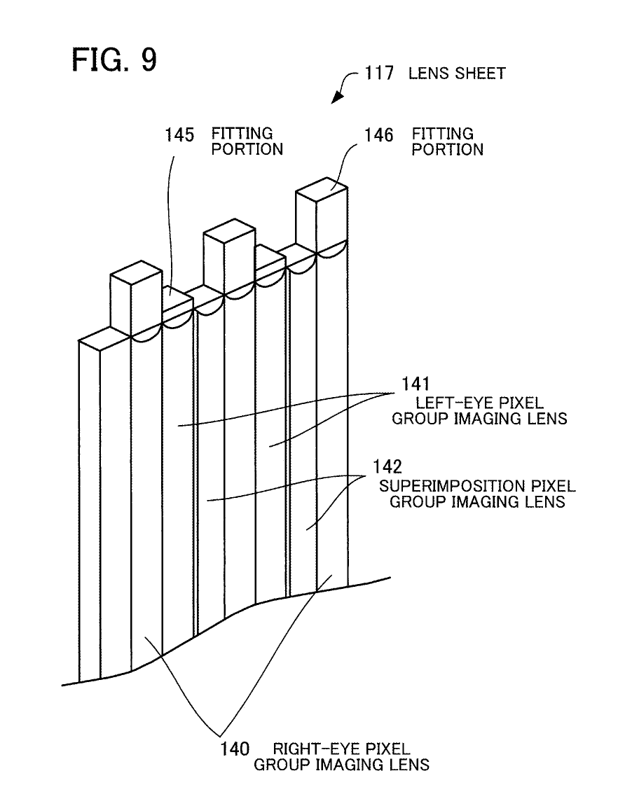

Next, with reference to FIGS. 9 to 13, an example of a structure of the lens sheet 117 and an example of lenses of the lens sheet 117 will be described. First, the structure of the lens sheet 117 will be described. FIG. 9 illustrates an exterior appearance of the lens sheet of the image display apparatus according to the second embodiment.

The lens sheet 117 is a thin plastic plate having a substantially rectangular shape of a size enough to cover the display screen of the monitor 110. The lens sheet 117 includes a lens array that faces toward a viewer when the lens sheet 117 is attached to the monitor 110.

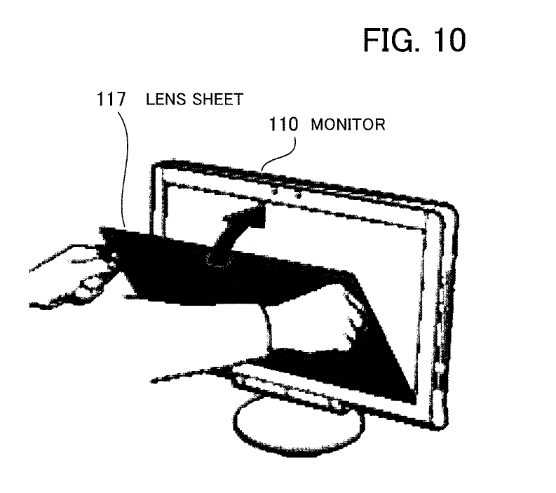

Also, for example, the lens sheet 117 includes fitting portions 145 and 146 that engage with the monitor 110, at an upper periphery which is one end in the extending direction of the cylindrical lenses. The fitting portions 145 and 146 have different heights to define the fitting position relative to the monitor 110. Thereby, in the image display apparatus 10, each cylindrical lens is positioned at a corresponding pixel group, as illustrated in FIG. 10.

FIG. 10 is an explanatory diagram of attachment of the lens sheet to the monitor. The lens sheet 117 is positioned by engaging the fitting portions 145 and 146 with fitting recesses (not depicted) of the monitor 110. Note that the fitting portions 145 and 146 may be provided over the entire length or at a part, e.g. a center part, of one periphery of the lens sheet 117. By providing the fitting portions 145 and 146 at the center part of one periphery of the lens sheet 117, the lens sheet 117 is attached to the monitor 110 with high precision in the image display apparatus 10.

Although, in the lens sheet 117, the fitting portions 145 and 146 for engaging with the monitor 110 are provided on the upper periphery, the fitting portions 145 and 146 may be provided on the lower periphery, the left periphery, or the right periphery, for example.

Also, in a production process of the monitor of the image display apparatus 10, the lens sheet 117 may be positioned using optical detection of attachment position. In this case, the lens sheet 117 is needless to include the fitting portions 145 and 146.

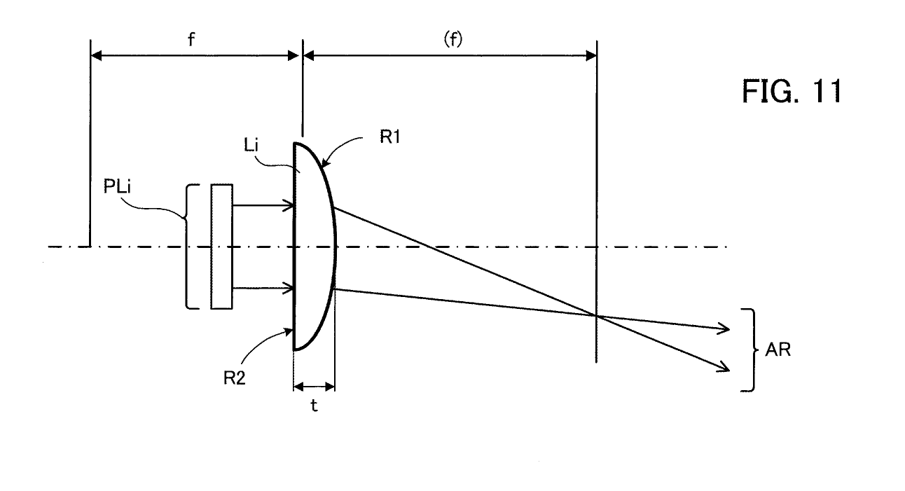

Next, with reference to FIG. 11, a view zone formed by a lenticular lens will be described. FIG. 11 is an explanatory diagram of a view zone formed by a lenticular lens. For example, FIG. 11 illustrates a view zone corresponding to a left-eye pixel group PLi in the stereoscopic image. Outgoing light from the left-eye pixel group PLi is refracted by a corresponding cylindrical lens Li, and thereby the view zone AR of the left-eye pixel group PLi is formed.

Here, R1 represents the curvature radius of each cylindrical lens seen from the stereoscopic image, and R2 represents the curvature radius of each cylindrical lens seen from a viewer, and f represents the focal length of each cylindrical lens of the side facing the stereoscopic image, and n represents the refractive index of each cylindrical lens, and t represents the thickness of each cylindrical lens. In this case, next equation (1) is obtained.

1/f=(n−1)·(1/R1−1/R2)+(n−1)·{(n−1)/n}·t/(R1·R2) (1)

In the present embodiment, a cylindrical lens is a plano-convex lens, and therefore the curvature radius R2 is infinite, and 1/R2 is “0”. Also, t/(R1·R2) is “0”. Thus, the above equation (1) is transformed into 1/f=(n−1)·(1/R1). The refractive index n is a fixed value decided by material of the cylindrical lens, and therefore the value of the focal length f is dependent on the curvature radius R1.

In this case, a distance p from the principal point of a cylindrical lens to a viewer is set longer than 0 and shorter than f, so that pixels of the stereoscopic image form an image in the image formation area of a predetermined width positioned at a constant distance away from the cylindrical lens. Next equation (2) is obtained.

tan(90−θ)=3q/f=3q·(r−1)/R1 (2)

where θ is the angle of image formation area, and q is the pixel width.

For example, assuming that pixel width q=0.415 mm, distance ED between eyes=70 mm, view distance (i.e. image formation distance) OD=2m (2000 mm), width of right-eye image view zone RA and width of left-eye image view zone LA=210 mm, the next calculation results are obtained from the equation (2).

tan θ1 is 210/2000, and therefore θ1 is 6° for the right-eye pixel group imaging lenses 140 and the left-eye pixel group imaging lenses 141. Since the width of the superimposed view zone OA is at least the distance ED between eyes (=70 mm) at the view distance (i.e. image formation distance) OD (=2m (2000 mm)), the next calculation result is obtained from the equation (2). tan θ2 is 70/2000, and therefore θ2 is 2°.

Thus, assuming that the refractive index of lens is 2.0, tan(90−6)=3×0.415×(2.0−1.0)/R1 is transformed into R1=0.13, with respect to θ1. Also, tan(90−2)=3×0.415×(2.0−1.0)/R2 is transformed into R2=0.043.

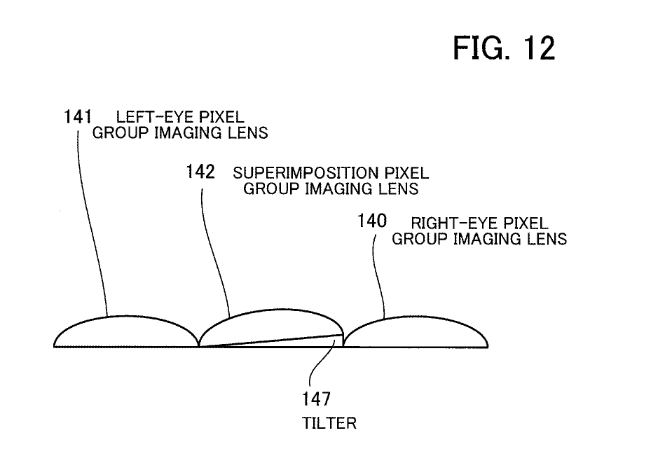

The aforementioned lenticular lens is provided on the lens sheet 117 as in FIG. 12. FIG. 12 is an explanatory diagram of shapes of cylindrical lenses of respective pixel groups.

In the lens sheet 117, a right-eye pixel group imaging lens 140, a left-eye pixel group imaging lens 141, and a superimposition pixel group imaging lens 142 are arrayed cyclically. FIG. 12 illustrates an array of cylindrical lenses of one cycle and omits other cylindrical lenses. The right-eye pixel group imaging lens 140 and the left-eye pixel group imaging lens 141 refracts outgoing light from the monitor 110 in such a manner that the right-eye image view zone RA and the left-eye image view zone LA are adjacent to each other. The superimposition pixel group imaging lens 142 is tilted toward the left-eye pixel group imaging lens 141 by a tilter 147. Thereby, the superimposition pixel group imaging lens 142 refracts outgoing light from the monitor 110 in such a manner that the superimposed view zone OA is adjacent to the right-eye image view zone RA and is superimposed on the left-eye image view zone LA.

Note that, since the superimposed view zone OA is narrower than the left-eye image view zone LA, the curvature radius of the superimposition pixel group imaging lens 142 is smaller than the curvature radius of the left-eye pixel group imaging lens 141.

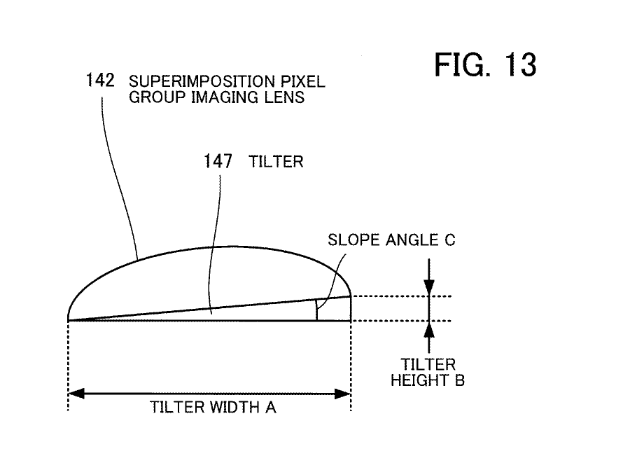

Here, with reference to FIG. 13, the tilter 147 will be described. FIG. 13 is an explanatory diagram of the shape of a superimposition pixel group imaging lens. The tilter 147 tilts a superimposition pixel group imaging lens 142 toward the image formation direction of the left-eye pixel group imaging lenses 141 to superimpose the superimposition image 12 on the left eye image 13. The tilter 147 has a bottom that defines a tilter width A and faces an aperture 144 of a pixels 143. Also, the tilter 147 has a slope angle C that defines a tilter height B, so as to tilt the superimposition pixel group imaging lens 142.

The tilter 147 is a triangle similar to a right triangle that has a side of view distance OD (i.e. image formation distance=2m (2000 mm)) and a side of a half of distance ED between eyes (=70 mm). Thus, assuming that the pixel width (width for covering the aperture 144) is 0.415 mm, the tilter height B is 0.007 mm on the basis of “2000:35=tilter width A (=0.415 mm):tilter height B”. Note that the tilter 147 may be a prism that is integral with or separated from the superimposition pixel group imaging lenses 142.

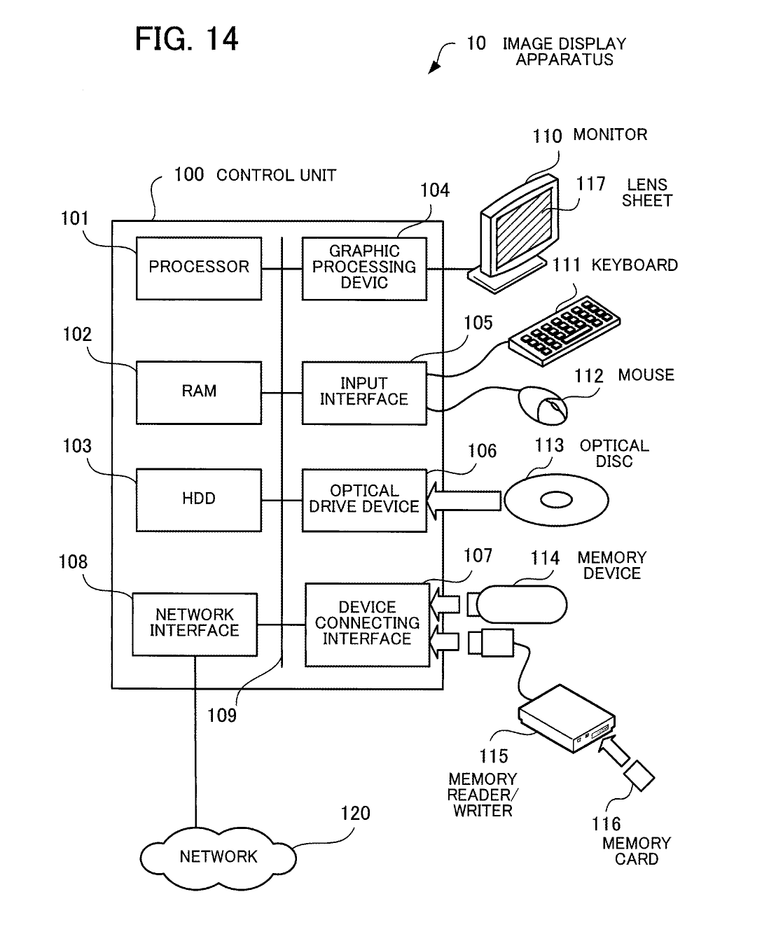

Next, with reference to FIG. 14, a hardware configuration of the image display apparatus of the second embodiment 10 will be described. FIG. 14 illustrates an exemplary hardware configuration of the image display apparatus according to the second embodiment.

The image display apparatus 10 includes a control unit (computer) 100 and a plurality of peripheral devices connected to the control unit 100. The control unit 100 is controlled by a processor 101 in its entirety. A random access memory (RAM) 102 and a plurality of peripheral devices are connected to the processor 101 via a bus 109. The processor 101 may be a multiprocessor. The processor 101 is, for example, a central processing unit (CPU), a micro processing unit (MPU), a digital signal processor (DSP), an application specific integrated circuit (ASIC), or a programmable logic device (PLD). Also, the processor 101 may be a combination of two or more elements selected from a CPU, an MPU, a DSP, an ASIC, and a PLD.

The RAM 102 is used as a main memory device of the control unit 100. The RAM 102 temporarily stores at least a part of operating system (OS) programs and application programs which are executed by the processor 101. Also, the RAM 102 stores various types of data that is used in processing by the processor 101.

The peripheral devices connected to the bus 109 include an HDD 103, a graphic processing device 104, an input interface 105, an optical drive device 106, a device connecting interface 107, and a network interface 108.

The HDD 103 magnetically writes data into, and reads data from, a built-in disk. The HDD 103 is used as an auxiliary memory device of the control unit 100. The HDD 103 stores OS programs, application programs, and various types of data. Note that the auxiliary memory device may be a semiconductor memory device, such as a flash memory.

The monitor 110 equipped with the lens sheet 117 is connected to a graphic processing device 104. The graphic processing device 104 displays images (right eye image 11, left eye image 13, and superimposition image 12) on the screen of the monitor 110, in accordance with an instruction from the processor 101.

A keyboard 111 and a mouse 112 are connected to the input interface 105. The input interface 105 relays a signal transmitted from the keyboard 111 and the mouse 112 to the processor 101. Note that the mouse 112 is an example of pointing device, and other pointing devices may be used. Other pointing devices are, for example, a touch panel, a tablet, a touch pad, and a trackball.

The optical drive device 106 reads data stored in an optical disc 113, utilizing laser light or the like. The optical disc 113 is a portable storage medium which stores data in a readable manner by reflection of light. The optical disc 113 is, for example, a DVD (Digital Versatile Disc), a DVD-RAM, a CD-ROM (Compact Disc Read Only Memory), and a CD-R (Recordable)/RW (ReWritable).

The device connecting interface 107 is a communication interface for connecting peripheral devices to the control unit 100. For example, a memory device 114 and a memory reader/writer 115 are connected to the device connecting interface 107. The memory device 114 is a storage medium having a communication function with the device connecting interface 107. The memory reader/writer 115 writes data into, or reads data from, a memory card 116. The memory card 116 is a storage medium of card type.

The network interface 108 is connected to a network 120. The network interface 108 transmits data to, and receives data from, other computers or communication devices via the network 120.

The above hardware configuration implements processing functions of the control unit 100 of the second embodiment. Note that the image display apparatus 1 of the first embodiment may also be implemented by the same hardware as the image display apparatus 10 illustrated in FIG. 14.

For example, the control unit 100 executes programs stored in a computer-readable storage medium to implement the processing functions of the second embodiment. Programs describing procedures executed by the control unit 100 may be stored in various storage media. For example, programs executed by the control unit 100 may be stored in the HDD 103. The processor 101 loads at least a part of programs stored in the HDD 103 into the RAM 102 and executes the programs. Also, programs executed by the control unit 100 may be stored in a portable storage medium, such as the optical disc 113, the memory device 114, and the memory card 116. For example, programs becomes executable after installed in the HDD 103 from a portable storage medium in accordance with control from the processor 101. Also, the processor 101 may read a program directly from a portable storage medium to execute the program.

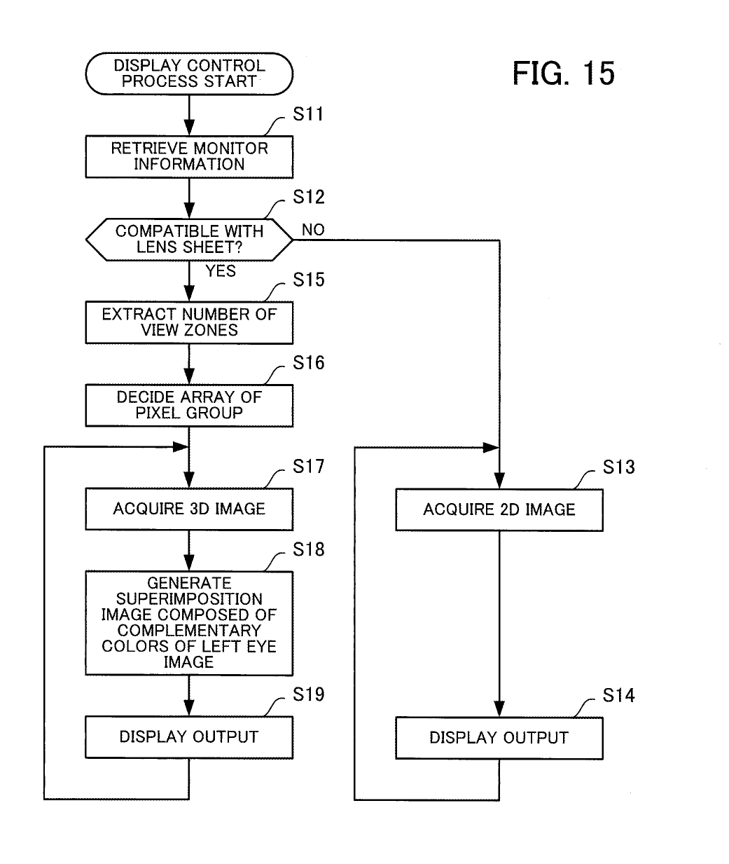

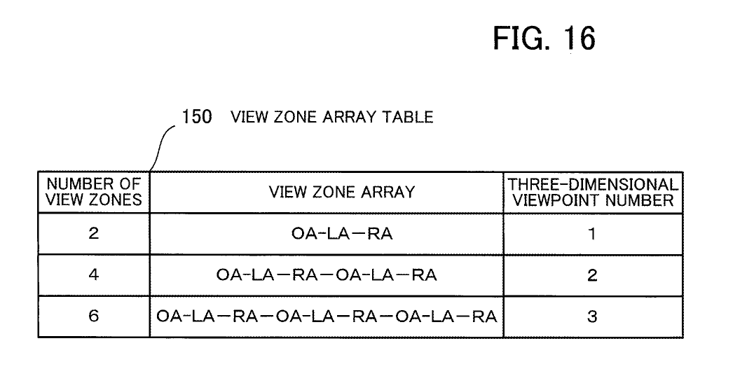

Next, with reference to FIG. 15, a display control process executed by the control unit 100 of the image display apparatus 10 will be described. FIG. 15 illustrates a flowchart of a display control process executed by the image display apparatus according to the second embodiment. The control unit 100 executes the display control process upon activation of the image display apparatus 10.

[Step S11] The control unit 100 retrieves monitor information from the monitor 110. The monitor information includes information of whether or not the monitor 110 is equipped with the lens sheet 117, the number of view zones, and resolution of the monitor 110, for example.

[Step S12] The control unit 100 determines whether or not the monitor 110 is compatible with a lens sheet, that is, whether or not the monitor 110 is equipped with the lens sheet 117, on the basis of the monitor information. If the monitor 110 is equipped with the lens sheet 117, the control unit 100 proceeds to step S15. On the other hand, if the monitor 110 is not equipped with the lens sheet 117, the control unit 100 proceeds to step S13.

[Step S13] The control unit 100 acquires a 2D image.

[Step S14] The control unit 100 outputs the image to the monitor 110 via the graphic processing device 104. Thereafter, the control unit 100 repeats step S13 and step S14.

[Step S15] The control unit 100 extracts the number of view zones from the monitor information.

[Step S16] The control unit 100 decides how pixel groups are arrayed on the basis of the number of view zones, with reference to a view zone array table. Here, with reference to FIG. 16, a view zone array table will be described. FIG. 16 illustrates an example of the view zone array table.

The view zone array table 150 is a data table which stores a view zone array and a three-dimensional viewpoint number in association with each number of view zones. The number of view zones is the number of the right-eye image view zones RA and the left-eye image view zones LA which are repeatedly located in the view region OF. The view zone array is the array of view zones including right-eye image view zones RA, left-eye image view zones LA, and superimposed view zones OA. The three-dimensional viewpoint number is the number of viewpoints from which a 3D image is viewable. Usually, the three-dimensional viewpoint number is half the number of view zones.

According to the view zone array table 150, when the number of view zones is “2”, the view zone array includes superimposed view zone OA, left-eye image view zone LA, and right-eye image view zone RA in this order from left, and the three-dimensional viewpoint number is “1”. Also, when the number of view zones is “4”, the view zone array includes two cycles of superimposed view zone OA, left-eye image view zone LA, and right-eye image view zone RA in this order from left, and the three-dimensional viewpoint number is “2”. Also, when the number of view zones is “6”, the view zone array includes three cycles of superimposed view zone OA, left-eye image view zone LA, and right-eye image view zone RA in this order from left, and the three-dimensional viewpoint number is “3”. Note that the numbers of view zones “2”, “4”, and “6” are just examples, and the number of view zones may be “8” or more.

Thus, the control unit 100 retrieves the number of view zones to decide which one of right-eye pixel group, left-eye pixel group, and superimposition pixel group is displayed on which pixels 143 of the monitor 110.

In the following, description returns to FIG. 15.

[Step S17] The control unit 100 acquires a 3D image (right eye image 11 and left eye image 13). For example, the control unit 100 may acquire a 3D image from 3D video content, or may execute an application program to generate a 3D image.

[Step S18] The control unit 100 generates a superimposition image 12, which is composed of complementary colors of the left eye image 13. In this case, the control unit 100 functions as a superimposition image generating unit.

[Step S19] The control unit 100 outputs images to the monitor 110 via the graphic processing device 104. In the following, the control unit 100 repeats steps S17 to S19.

Thereby, the image display apparatus 10 displays the right eye image 11, the left eye image 13, and the superimposition image 12 on the pixels 143 of the monitor 110. Although in the above example the superimposition image 12 is generated by the control unit 100, the superimposition image 12 may be generated by the graphic processing device 104, for example. In this case, the graphic processing device 104 functions as a superimposition image generating unit.

### Third Embodiment

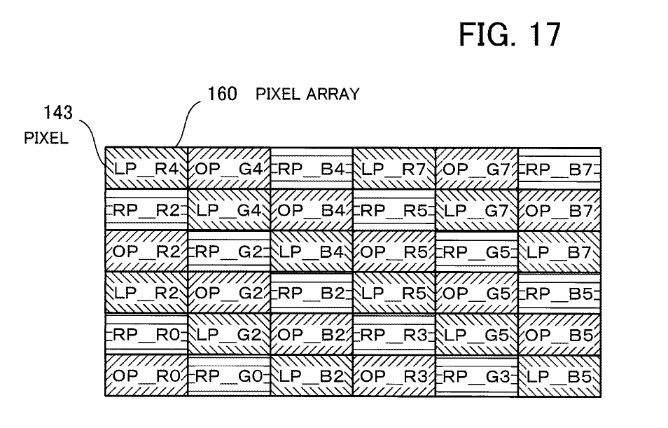

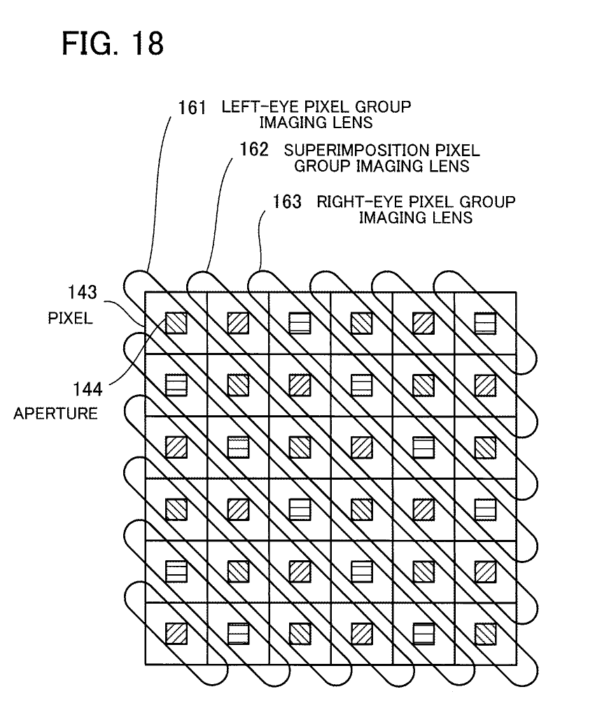

Next, with reference to FIGS. 17 and 18, relationship between a pixel array of the monitor and cylindrical lenses of the lens sheet of the third embodiment will be described. The third embodiment is different from the second embodiment in that an array of right-eye pixel groups, left-eye pixel groups, and superimposition pixel groups is in a diagonal direction relative to the pixel array of the monitor, as compared to the second embodiment in which right-eye pixel groups, left-eye pixel groups, and superimposition pixel groups are cyclically arrayed in the lateral direction. First, a pixel array of the monitor will be described.

The monitor of the image display apparatus according to the third embodiment is same as that of the second embodiment in that pixels are vertically and laterally arranged in a matrix. In a stereoscopic image displayed on the monitor, the right eye image 11, the left eye image 13, and the superimposition image 12 are each divided into rectangular strips of pixel groups in a diagonally right-down direction. Thus, the divided regions corresponding to the right eye image 11, the divided regions corresponding to the left eye image 13, and the divided regions corresponding to the superimposition image 12 are alternatingly located in the diagonally right-down direction.

Here, a pixel array example illustrated in FIG. 17 will be described. FIG. 17 illustrates an example of the pixel array of the monitor of the image display apparatus according to the third embodiment.

The pixel array 160 is a pixel array example of the monitor according to the third embodiment. For example, the pixel group including pixels 143 (“OP_R2”, “OP_G2”, “OP_B2”, “OP_R3”, . . . ) arrayed in the diagonally right-down direction is the n-th pixel group of the superimposition image 12 as counted from the left. The pixel group including pixels 143 (“RP_R2”, “RP_G2”, “RP_B2”, “RP_R3”, “RP_G3”, . . . ) arrayed in the diagonally right-down direction is the n-th pixel group of the right eye image 11 as counted from the left. The pixel group including pixels 143 (“LP_R4”, “LP_G4”, “LP_B4”, “LP_R5”, “LP_G5”, “LP_B5”, . . . ) arrayed in the diagonally right-down direction is the n-th pixel group of the left eye image 13 as counted from the left. In the same way, pixel groups of right eye image 11, pixel groups of left eye image 13, and pixel groups of the superimposition image 12 are arrayed repeatedly.

In the third embodiment, the lens sheet is positioned corresponding to pixel groups that are divided into rectangular strips arrayed in the diagonally right-down direction. FIG. 18 illustrates relationship between a pixel array of the monitor and cylindrical lenses of the lens sheet according to the third embodiment. FIG. 18 illustrates relationship between a pixel array of the monitor and cylindrical lenses in the image display apparatus according to the third embodiment.

The lens sheet is a lenticular lens including a plurality of cylindrical lenses each extending in the diagonally right-down direction and arrayed in the diagonally left-down direction. The cylindrical lenses include left-eye pixel group imaging lenses 161, superimposition pixel group imaging lenses 162, and right-eye pixel group imaging lenses 163. The right-eye pixel group imaging lenses 163, the left-eye pixel group imaging lenses 161, and the superimposition pixel group imaging lenses 162 are arrayed cyclically in the diagonally left-down direction of the lens sheet 117.

A right-eye pixel group imaging lens 163 is provided corresponding to a right-eye pixel group including pixels 143 arrayed in the diagonally right-down direction. A left-eye pixel group imaging lens 161 is provided corresponding to a left-eye pixel group including pixels 143 arrayed in the diagonally right-down direction. A superimposition pixel group imaging lens 162 is provided corresponding to a superimposition pixel group including pixels 143 arrayed in the diagonally right-down direction. Thereby, outgoing lights from an R pixel, a G pixel, and a B pixel of a pixel groups form an image in the view region OF to constitute one pixel for displaying a color. For example, the right-eye pixel group imaging lenses 163 causes a R pixel “RP_R5”, a G pixel “RP_G5”, and a B pixel “RP_B5” to form an image in the view region OF to express one pixel for displaying a color.

As described above, since, in the image display apparatus of the third embodiment, the right-eye pixel groups, the left-eye pixel groups, and the superimposition pixel groups are arrayed in the diagonal direction in relation to the pixel array of the monitor, its resolution is made higher in the lateral direction (horizontal direction), as compared to the image display apparatus 10 of the second embodiment. Thus, the image display apparatus of the third embodiment can display a 3D image of high lateral resolution to a viewer.

Note that each pixel 143 includes an aperture 144 for projecting a light, and each cylindrical lens is positioned to collect an outgoing light from the aperture 144 of the corresponding pixels 143.

Note that the above processing functions are implemented by a computer. In that case, the image display apparatuses 1 and 10 and the image display apparatus of the third embodiment are provided with programs describing procedures for implementing their functions. By executing these programs in a computer, the above processing functions are implemented in the computer. The programs describing procedures may be stored in s computer-readable storage medium (including s portable storage medium). The computer-readable storage medium is, for example, a magnetic storage device, an optical disc, a magneto-optical storage medium, or a semiconductor memory. The magnetic storage device is, for example, a hard disk device (HDD), a flexible disk (FD), or a magnetic tape. The optical disc is, for example, a DVD (Digital Versatile Disc), a DVD-RAM, a CD-ROM, or a CD-R (Recordable)/RW (ReWritable). The magneto-optical storage medium is, for example, an MO (Magneto-Optical disk).

When a program is put on the market, a portable storage medium, such as a DVD and a CD-ROM, having the program stored therein is sold, for example. Also, a program may be stored in a memory device of a server computer to be transmitted from the server computer to other computers via a network.

A computer reads a program stored in a portable storage medium or receives a program transmitted from a server computer, and stores the program in a memory device of the computer, for example. Then, the computer reads the program from the memory device and executes a process in accordance with the program. Note that the computer may read a program directly from a portable storage medium and execute a process in accordance with the program. Also, the computer may execute a process in accordance with a program, each time a program is forwarded from the server computer. In one aspect, unnaturalness of a viewed image is reduced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An image display apparatus for displaying a 3D image that is viewable from multiple viewpoints, comprising:
an image display unit that displays a first image, a second image, and a third image; and
a view zone setting unit that sets a view zone of the first image at a right-eye image view zone, and a view zone of the second image at a left-eye image view zone, and a view zone of the third image at a superimposed view zone that is adjacent to one of the right-eye image view zone and the left-eye image view zone and is superimposed on a part of the other of the right-eye image view zone and the left-eye image view zone, at a boundary between the right-eye image view zone and the left-eye image view zone.

2. The image display apparatus according to claim 1, wherein
the third image is an image that is superimposed on the first image or the second image in the superimposed view zone to display a specific image.

3. The image display apparatus according to claim 2, wherein
the third image is a complementary color image of the first image or the second image.

4. The image display apparatus according to claim 1, wherein
a width of the superimposed view zone is set equal to or greater than a distance between eyes of a viewer.

5. The image display apparatus according to claim 1, wherein
the view zone setting unit is a lenticular lens that refracts outgoing light corresponding to the first image toward the right-eye image view zone, and outgoing light corresponding to the second image toward the left-eye image view zone, and outgoing light corresponding to the third image toward the superimposed view zone.

6. The image display apparatus according to claim 5, wherein
the lenticular lens includes a plurality of cylindrical lenses each extending along a pixel array direction of the first image, the second image, and the third image, and
the cylindrical lenses extending along the pixel array direction of the third image are tilted relative to the cylindrical lenses extending along the pixel array direction of the first image or the second image, to superimpose the third image on the first image or the second image in the superimposed view zone.

7. The image display apparatus according to claim 3, further comprising
a third image generating unit that generates the third image by obtaining the first image or the second image and converting colors of the obtained image to complementary colors thereof.

8. A lenticular lens that refracts outgoing light corresponding to a first image toward a right-eye image view zone, and outgoing light corresponding to a second image toward a left-eye image view zone, and outgoing light corresponding to a third image toward a superimposed view zone that is adjacent to one of the right-eye image view zone and the left-eye image view zone and is superimposed on a part of the other of the right-eye image view zone and the left-eye image view zone, at a boundary between the right-eye image view zone and the left-eye image view zone.

9. The lenticular lens according to claim 8, comprising
a plurality of cylindrical lenses each extending along a pixel array direction of the first image, the second image, and the third image.

10. The lenticular lens according to claim 9, wherein
the cylindrical lenses extending along the pixel array direction of the third image are tilted relative to the cylindrical lenses extending along the pixel array direction of the first image or the second image, to superimpose the third image on the first image or the second image in the superimposed view zone.

11. An image display method of an image display apparatus for displaying a 3D image that is viewable from multiple viewpoints, the image display method comprising:
displaying a first image, a second image, and a third image on an image display unit; and
setting a view zone of the first image at a right-eye image view zone, and a view zone of the second image at a left-eye image view zone, and a view zone of the third image at a superimposed view zone that is adjacent to one of the right-eye image view zone and the left-eye image view zone and is superimposed on a part of the other of the right-eye image view zone and the left-eye image view zone, at a boundary between the right-eye image view zone and the left-eye image view zone.

12. The image display method according to claim 11, wherein
the third image is an image that is superimposed on the first image or the second image in the superimposed view zone to display a specific image.

13. The image display method according to claim 12, further comprising
generating the third image by converting colors of the first image or the second image to complementary colors thereof.
